(19) United States
(12) Patent Application Publication
(10) Pub. No.: US 2022/0381057 A1
(43) Pub. Date: Dec. 1, 2022

(54) APPARATUS AND LOCK THEREOF

(71) Applicant: DEZHAO XIANG, SHENZHEN (CN)

(72) Inventor: DEZHAO XIANG, SHENZHEN (CN)

(21) Appl. No.: 17/883,636

(22) Filed: Aug. 9, 2022

Related U.S. Application Data
(63) Continuation-in-part of application No. 17/118,620, filed on Dec. 11, 2020.

(51) Int. Cl. E05B 15/00; E05B 1/00; E05B 55/00

(52) U.S. Cl. CPC E05B 15/0026; E05B 1/0007; E05B 55/005

(57) ABSTRACT

Discloses is a lock for releasably locking a first component to a second component. The lock includes a driving assembly, configured to be installed on the first component and including a rotatable cylinder housing; a transmission assembly, including a cylinder core which insertable by a key and is in torque-transmission connection with the driving assembly; and a locking assembly, connected with the transmission assembly and having a first position decoupled from the second component and a second position coupled with the second component, wherein the driving assembly can move relative to the first component and drive the locking assembly by means of the movement to complete the locking, and the locking includes: making the locking assembly move to the second position from the first position and be locked there.

### CROSS REFERENCE OF RELATED APPLICATIONS

This application is a Continuation-in-Part application of my application U.S. Ser. No. 17/118,620 filed on Dec. 11, 2020 entitled “Rotary Cylinder Assembly”, currently pending, this application also claims priority of Chinese Patent Application No. 202210546812.0 filed on May 19, 2022, the entire contents of which are hereby incorporated by reference.

### TECHNICAL FIELD

The present disclosure relates to the field of locks and applications thereof, and particularly to a keyless dead-locking lock.

### BACKGROUND

Locks refer to appliances playing a role of locking an enclosed space, and are widely applied in houses, businesses, offices, public facilities and the like.

A complete mechanical lock includes a lock body, a cylinder and a key.

Currently, mechanical door locks widely applied can only achieve double lock with keys, which is very inconvenient for the elderly, children, the disabled, people with babies in their arms or whose hands are unavailable.

How to solve a problem that double locking the mechanical door lock without the key has become a technical problem needing to be solved urgently.

### SUMMARY

### (1) Objective of the Present Disclosure

In order to solve the technical problems existing in the background art, the present disclosure provides a lock, which brings the convenience to rotate a lock head assembly to drive a spindle transmission assembly to realize that a door is mechanically latched without a key.

### (2) Technical Solution

In order to solve the above problems, in a first aspect, the present disclosure provides a lock for releasably latching a first component to a second component. The lock includes a driving assembly, configured to be installed on the first component and including a rotatable cylinder housing; a transmission assembly, including a cylinder core which is insertable by a key and is in torque-transmission connection with the driving assembly; a locking assembly, connected with the transmission assembly and having a first position decoupled from the second component and a second position coupled with the second component, wherein the driving assembly can move relative to the first component and drive the locking assembly by means of the movement to complete the locking, and the locking includes: making the locking assembly move to the second position from the first position and be locked there.

In some embodiments, the driving assembly includes an extending portion at least partially protruding from the first component and configured to receive an external driving force.

In some embodiments, the lock further includes a knob assembly in torque-transmission connection with the driving assembly, wherein the knob assembly receives the external driving force, and drives the driving assembly to move.

In some embodiments, the knob assembly is covered on an outer side of one end of the transmission assembly away from the locking assembly.

In some embodiments, the knob assembly is in torque-transmission connection with the locking assembly, and drives the locking assembly to move, thereby completing the locking.

In some embodiments, the transmission assembly includes an intermediate transmission member, wherein the knob assembly is in torque-transmission connection with the intermediate transmission member, the transmission assembly includes a spindle; the spindle is in torque-transmission connection with the cylinder core, and is in torque-transmission connection with the intermediate transmission member; the intermediate transmission member is drivable by the knob assembly or the spindle to move, such that the intermediate transmission member drives the locking assembly to complete the locking.

In some embodiments, the knob assembly includes a first transmission member, the intermediate transmission member includes a second transmission member, and the first transmission member can drive the second transmission member to move, thereby driving the locking assembly to complete the locking.

In some embodiments, the knob assembly includes an inner opening, the first transmission member protrudes radially inwards from the inner opening, and the second transmission member protrudes towards the inner opening.

In some embodiments, the knob assembly includes a knob transmission member, and the inner opening is provided in the knob transmission member.

In some embodiments, the intermediate transmission member includes a spindle interface, wherein the spindle interface is in clearance fit with the spindle, and the spindle can drive the intermediate transmission member to move through the spindle interface.

In some embodiments, the intermediate transmission member has a first setting state and a second setting state, wherein in the first setting state, the second transmission member is disposed on a path along which the first transmission member moves in a first direction, and can be driven by the first transmission member; and in the second setting state, the second transmission member is disposed on a path along which the first transmission member moves in a second direction opposite to the first direction, and can be driven by the first transmission member.

In some embodiments, the transmission connection between the knob assembly and the intermediate transmission member is clutch connection, and the transmission connection between the spindle and the intermediate transmission member is torque-proof connection, wherein when the spindle or the knob assembly moves in the first direction, the locking assembly is driven by the intermediate transmission member to complete the locking; and when the spindle moves in the second direction, the locking assembly can be driven to move from the second position to the first position to achieve unlocking.

In some embodiments, the locking assembly includes a latching member, wherein the latching member is in torque-transmission connection with the intermediate transmission member, and the latching member includes a connecting portion which is fixedly connectable with the second component.

In some embodiments, the latching member is formed to be installed on the intermediate transmission member reversely, and after the latching member is reversely installed on the intermediate transmission member, the connecting portion can move in a direction opposite to that before the latching member is reversely installed on the intermediate transmission member, and is fixedly connected with another second component disposed in an orientation opposite to that of the second component.

In some embodiments, the locking assembly includes a lock body and a latching member, wherein the latching member is in torque-transmission connection with the intermediate transmission member, and the lock body is driven by the latching member to complete the locking.

In some embodiments, the lock further includes a second knob, wherein the latching member is disposed through the lock body, one end of the latching member is in torque-transmission connection with the second knob and the other end of the latching member is in torque-transmission connection with the intermediate transmission member, such that the lock body can be driven to be locked or unlocked by rotating the second knob.

In a second aspect, the present disclosure provides an apparatus, including the above lock, a first component and a second component, wherein the first component is connected with the lock, and the lock is configured to releasably lock the first portion to the second portion.

The above-mentioned technical solution of the present disclosure has the following beneficial technical effects:

Under a continuous action of an external torque, the rotary lock head can continue to rotate by rotating the knob, thereby driving the spindle to rotate; and then a lock bolt can be driven to move in a direction close to a lock hole by a transmission torque of the spindle to complete a dead-locking operation.

### BRIEF DESCRIPTION OF THE DRAWINGS

FIG. 1 is an exploded schematic view of a lock according to an embodiment of the present disclosure.

FIG. 2 is another exploded schematic view of the lock shown in FIG. 1.

FIG. 3 is another exploded schematic view of the lock shown in FIG. 1.

FIG. 4 is a schematic structural view of a knob assembly shown in FIG. 3.

FIG. 5 is a schematic structural view of a knob transmission member shown in FIG. 1.

FIG. 6 is a sectional view of the lock shown in FIG. 1.

FIG. 7a is a schematic view of an intermediate transmission member of the lock shown in FIG. 1 in a first mounting state, wherein a knob assembly is removed to show its internal structure more clearly.

FIG. 7b is a schematic view of the intermediate transmission member of the lock shown in FIG. 7a in the first mounting state, wherein the intermediate transmission member and a latching member rotate along a direction A to a locking position.

FIG. 8a is a schematic view of the intermediate transmission member of the lock shown in FIG. 1 in a second mounting state, wherein the knob assembly is removed to show its internal structure more clearly.

FIG. 8b is a schematic view of the intermediate transmission member of the lock shown in FIG. 8a in the second mounting state, wherein the intermediate transmission member and the latching member rotate along a direction C to the locking position.

FIG. 9 is a schematic view of connecting the lock according to the present disclosure to a lock body.

FIG. 10 is an exploded schematic view of a lock according to another embodiment of the present disclosure.

FIG. 11 is a schematic view of an apparatus including a lock according to the present disclosure.

In the figures: 10, knob assembly; 11, knob; 112, cylinder mounting hole; 114, transmission opening; 12, knob transmission member; 122, inner opening; 124, first transmission member; 126, torsion spring holding portion; 128, limiting portion; 13, torsion spring; 132, limiting leg; 14, bearing; 19, cylinder housing; 30, transmission assembly; 31, spindle; 32, shifting transmission member; 322, second transmission member; 324, spindle interface; 326, limiting portion; 34, cylinder core; 342, keyhole; 344, spindle receiving end; 40, fixing assembly; 41, mounting seat; 412, mounting bottom plate; 414, mounting portion; 416, mounting hole; 42, positioning and latching plate; 43, positioning portion; 44, washer; 45, latching member; 451, driving rod; 46, case; 462, reset holding portion; 464, rotation limiting portion; 47, rod-shaped latching member; 48, second fixing seat; 50, lock body; 54, drive connecting portion; 61, second knob; 62, second mounting seat; 100, lock; 101, lock; 200, apparatus; 201, first portion; 202, second portion; 300, lock body; and 301, lock bolt.

### DESCRIPTION OF THE EMBODIMENTS

In order to make the objectives, technical solutions and advantages of the present disclosure clearer, the present disclosure will be further described in detail below reference is made to specific embodiments and accompanying drawings. It should be understood that these descriptions are exemplary only and are not intended to limit the scope of the present disclosure. Also, in the following description, descriptions of well-known structures and techniques will be omitted to avoid unnecessarily obscuring the concepts of the present disclosure.

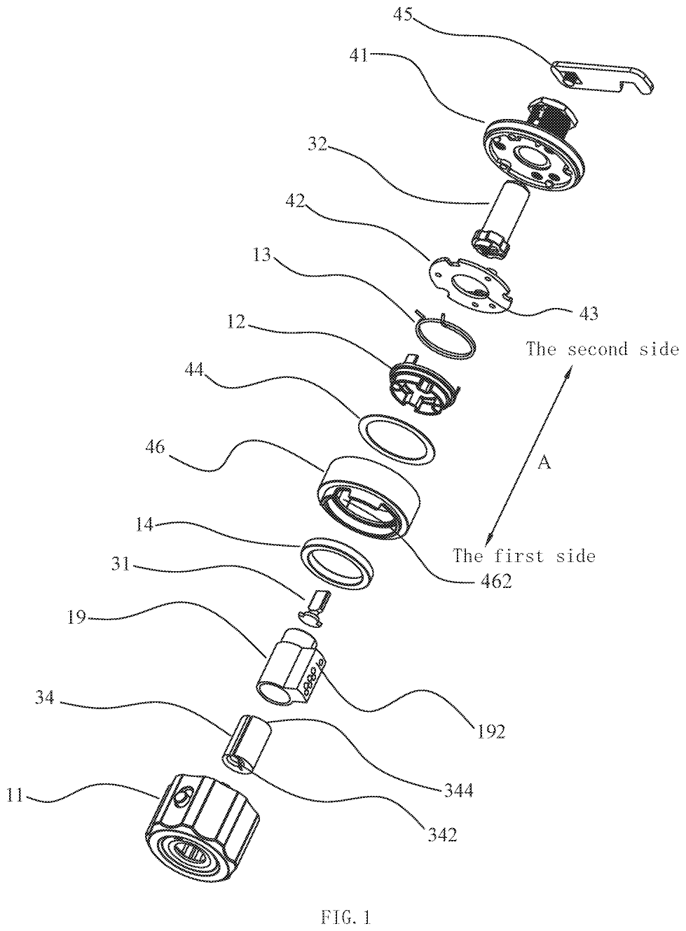

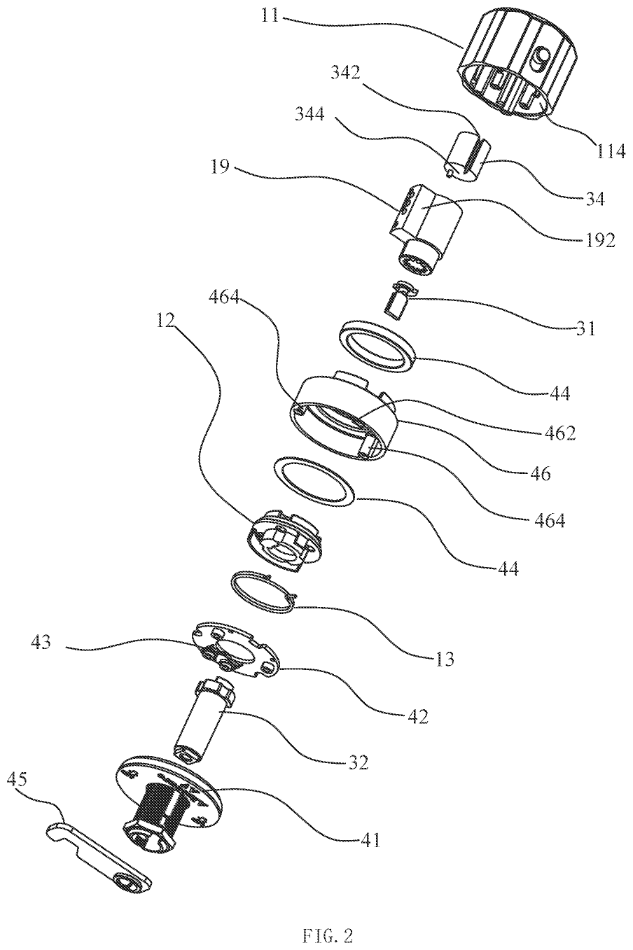

FIG. 1 to FIG. 3 show an embodiment of a lock of the present disclosure, which includes a driving assembly, a knob assembly 10, a transmission assembly 30, a fixing assembly 40 and a locking assembly. The knob assembly 10 is in torque-transmission connection with the driving assembly. The driving assembly is in torque-transmission connection with the driving assembly 30. The knob assembly 10 can be driven by an external acting force to move. The driving assembly 30 is driven by the movement of the driving assembly to rotate relative to the fixing assembly 40. The locking assembly is in torque-transmission connection with the transmission assembly 30, the fixing assembly 40 can be fixed to a first component to be locked, such as a door or a window. At least one portion of the locking assembly can be driven by the transmission assembly 30 to move relative to a second component. The movement enables the locking assembly to move from a first position decoupled from the second component to a second position coupled to the second component to achieve the locking. For example, the locking may include: at least one portion of the locking assembly hooks or is engaged with a portion of the second component in the second position and lock the same.

In this embodiment, the driving assembly includes a cylinder housing 19. The knob assembly 10 includes a knob 11 in torque-transmission connection with the cylinder housing 19, and a knob transmission member 12 fixedly connected with the knob 11. The knob 11 includes a cylinder mounting hole 112 and a transmission opening 114. The knob 11 is fixedly connected with the knob transmission member 12 by means of, for example, a bolt, and the knob transmission member 12 includes a first transmission member 124.

In this embodiment, the transmission assembly 30 includes a cylinder core 34, an intermediate transmission member and a spindle 31 in torque-transmission with the intermediate transmission member. For example, the intermediate transmission member includes a shifting transmission member 32. The cylinder core 34 can be at least partially inserted into the cylinder housing 19. The cylinder core 34 includes a keyhole 342 which is insertable by a key, the keyhole 342 is disposed towards the outside of the knob 11 through the cylinder core mounting hole 112 of the knob 11, such that the keyhole 342 is accessible from the outside of the knob 11. Meanwhile, at least one portion of the cylinder core 34 is accessible from the transmission opening 114 of the knob 11. The shifting transmission member 32 includes a spindle interface 324 for receiving at least one portion of the spindle 31. On the one hand, the spindle 31 is in torque-transmission connection with the cylinder core 34 through the transmission opening 114 of the knob 11. On the other hand, the spindle 31 is in torque-transmission connection with the spindle interface 324, such that the shifting transmission member 32 can be driven to move by the rotation of the spindle 31. The shifting transmission member 32 further includes a second transmission member 322, and the second transmission member 322 is at least partially disposed in a travel path along which the first transmission member 124 moves, such that the second transmission member 322 can move while abutting against the first transmission member 124, thus the shifting transmission member 32 is driven to move. The shifting transmission member 32 is coupled with the locking assembly and drives the locking assembly to move for achieving the locking. In this embodiment, the locking assembly includes a latching member 45.

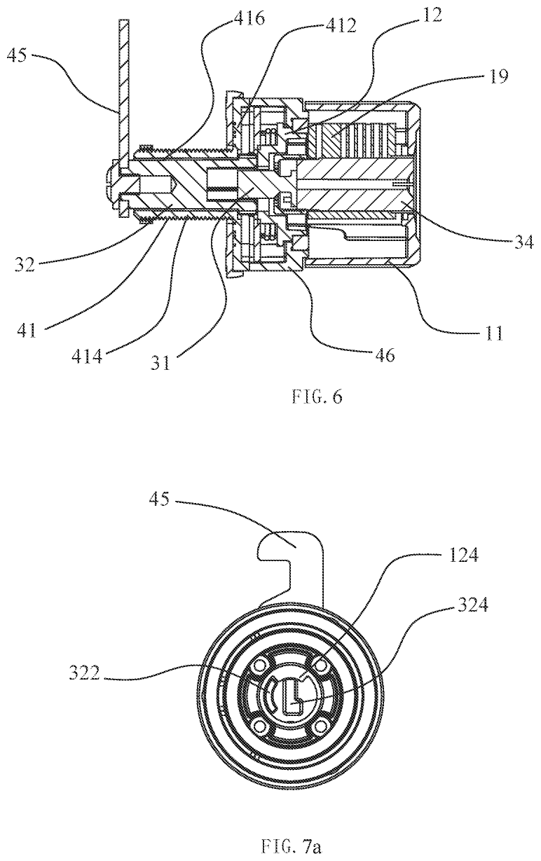

In addition, reference is made to FIG. 6. In this embodiment, the fixing assembly 40 includes a mounting seat 41 and a case 46 fixed to the mounting seat 41. The mounting seat 41 includes a mounting bottom plate 412 and a mounting portion 414 protruding from one end surface of the mounting bottom plate 412. The mounting portion 414 is provided with a mounting hole 416 therein, which penetrate through the mounting portion 414 and the mounting bottom plate 412. The case 46 has two opened sides, one of which is disposed towards and fixedly connected with the mounting bottom plate 412. The mounting portion 414 can be fixed to the first component to be locked, such as a door, a window or the like, by means of a screw connection. Moreover, the mounting portion 414 can penetrate through the first component, such that the mounting hole 416 is exposed from the other side of the first component.

Various parts of the lock according to the embodiment in FIG. 1 to FIG. 3 are generally arranged one above another along a mounting direction A. For the convenience of description, one side along the mounting direction A away from the latching member 45 towards the knob 11 is referred to as a first side, and the other side away from the knob 11 towards the latching member 45 is referred to as a second side.

The knob 11 is hollow therein, and a first side of the knob 11 is provided with a cylinder mounting hole 112 opened along the mounting direction A. The knob 11 further defines a transmission opening 114 opened in the second side along the mounting direction A. Both the cylinder mounting hole 112 and the transmission opening 114 are communicated with an internal space of the knob 11. The knob 11 is further provided with a plurality of internal threaded posts therein which protrudes along the mounting direction A. An accommodating space is defined among the plurality of internal threaded posts, and is adapted for accommodating and fixing the cylinder housing 19. In this embodiment, the cylinder housing 19 at least partially protrudes into the accommodating space through the transmission opening 114. The cylinder housing 19 includes a substantially tubular main body and a protruding portion 192, wherein the protruding portion 192 protrudes radially from a side portion of the tubular body, and extends between at least two of the internal threaded posts, thereby fixing the cylinder housing 19 to the knob 11.

The cylinder core 34 is at least partially disposed in the cylinder housing 19, and has a keyhole 342 disposed towards the first side of the mounting direction A and a spindle receiving end 344 disposed towards the second side of the mounting direction A. The spindle receiving end 344 is in a clutch mode transmission connection with the spindle 31, that is, the spindle receiving end 344 can drive the spindle 31 to rotate in a first direction, and can rotate relative to the spindle 31 in a second direction opposite to the first direction to be disengaged there from. Also, the spindle receiving end 344 can drive the spindle 31 to rotate in the second direction, and can rotate relative to the spindle 31 in the first direction to be disengaged there from. There is a clutch angle within which the spindle receiving end 344 is idle without engaged with the spindle 31 along the first direction and the second direction.

The knob transmission member 12 includes a plurality of bolt mounting holes in one-to-one correspondence to the internal threaded posts of the knob 11, such that the knob transmission member 12 can be fixedly connected with the knob 11 along the mounting direction A by means of bolts. The knob transmission member 12 includes an inner opening 122 penetrating along the mounting direction A, and one portion of an inner wall of the inner opening 122 protrudes radially inwards to form the first transmission member 124.

The cylinder core 34 and the cylinder housing 19 can maintain a locked state without rotating relative to each other. By inserting a key corresponding to the cylinder core 34 into the cylinder core 34, the locked state between the cylinder housing 19 and the cylinder core 34 can be released and can rotate relative one another. This may be achieved by for example, providing a plurality of radially slidable locking pins on the cylinder core and/or the cylinder housing, the locking pins are arranged corresponding to a tooth profile of the key, and end portions of the plurality of locking pins are flush with a contact surface of the cylinder core and the cylinder housing upon insertion of the key. One end of the spindle 31 is in clutch connection to the spindle receiving end 344 of the cylinder core 34, and the other end of the spindle 31 is arranged towards the second side of the mounting direction A and is connected to the spindle interface 324 of the shifting transmission member 32. The spindle interface 324 is in clearance fit with the spindle 31. The second transmission member 322 is disposed at one end of the shifting transmission member 32 facing the first side, and protrudes from the end surface towards the first side. The shifting transmission member 32 is disposed through the mounting seat 41 along the mounting direction A, and protrudes from the mounting seat 41 from the second side. A portion protruding from the second side is fixedly connected with the latching member 45. The latching member 45 includes a connecting portion that can be fixedly connected with a second component, and the connecting portion is adapted for hooking or being engaged with at least one portion of the second component, so as to realize that the first component to be locked is releasably latched to the second component. It should be understood that, in other embodiments, the latching member 45 can be connected with a lock body and drive the lock body, such that a lock bolt of the lock body extends to be coupled with the second component, so as to releasably latch the first component to be locked to the second component.

It should be understood that, in other embodiments, the first transmission member may be arranged to protrude in an axial direction, the second transmission member may be arranged to protrude in a radial direction, or both of them may be arranged to protrude in the axial direction or the radial direction, as long as the first transmission member can be in torque-transmission connection with the second transmission member in a rotation direction. The knob and the knob transmission member may be formed integrally, i.e., as a single piece, and the knob transmission member is formed as one portion of the knob. In this case, both the inner opening and the first transmission member may be defined in the knob. In addition, the knob may be designed in other forms such as a handle or a lever, and the first transmission member may be arranged to be in other movement modes such as a swinging movement or a linear movement. Similarly, the second transmission member may be arranged to be in other movements such as a swinging movement or a linear movement. In addition, the first transmission member may be directly formed on the cylinder housing. In this embodiment, knob can be omitted, and the cylinder housing may be directly operated for achieving the locking.

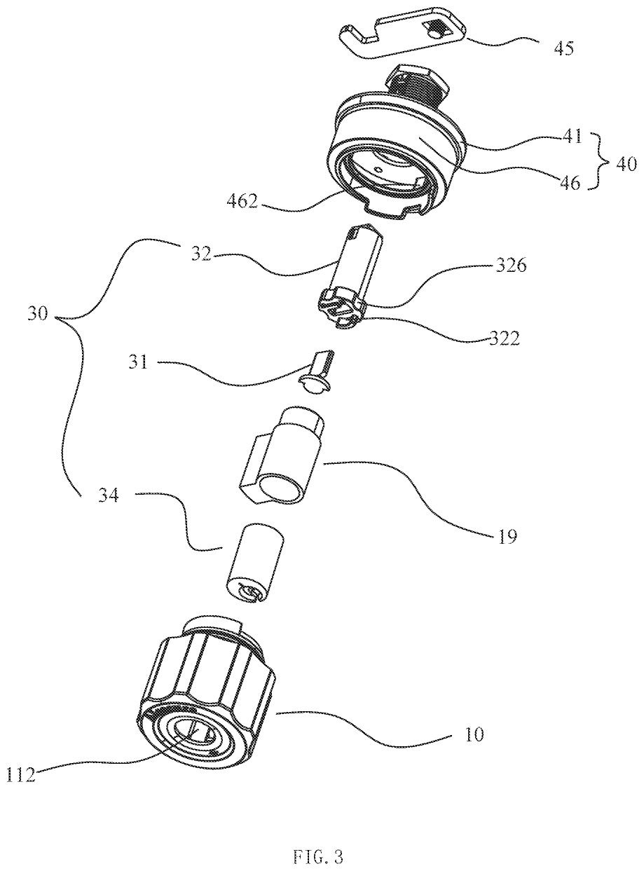

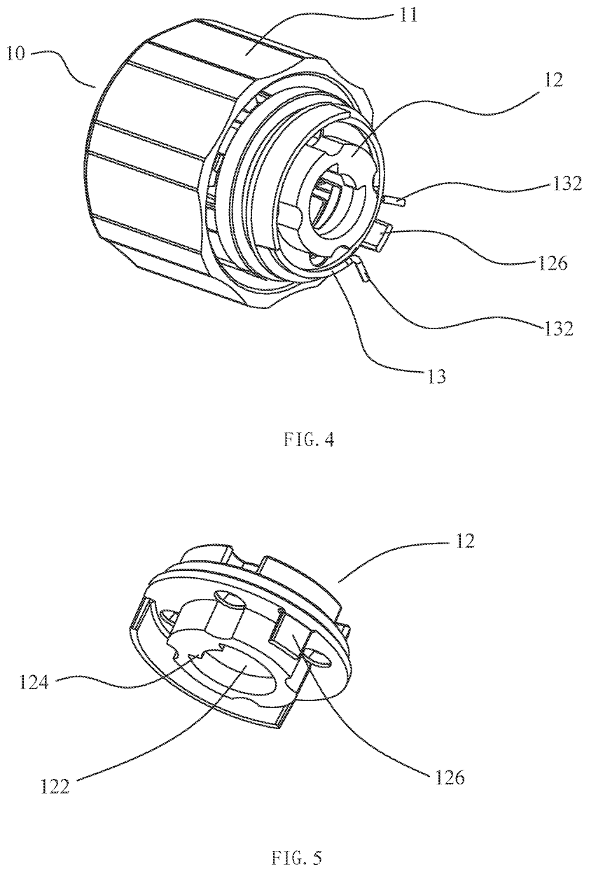

Reference is made to FIG. 3 to FIG. 5. In this embodiment, the case 46 includes a substantially cylindrical inner cavity, and further includes a reset holding portion 462 radially protruding inwardly into the inner cavity. The knob assembly 10 includes a torsion spring 13. The knob transmission member 12 includes a spring holding portion 126 protruding towards the second side. The torsion spring 13 includes a ring-shaped main body formed by coiling a spring wire. Two ends of the spring wire extend radially outwards to form two limiting legs 132. In an initial unlocked state without a driving force applied, a main body of the torsion spring 13 is arranged around the mounting direction A, the spring holding portion 126 is arranged adjacent to the reset holding portion 462, wherein the reset holding portion 462 is disposed on a radial outer side of the spring holding portion 126, and the two limiting legs 132 are respectively disposed on two sides of the spring holding portion 126 (and the reset holding portion 462) in a circumferential direction. When the knob transmission member 12 rotates relative to the case 46, one of the two limiting legs 132 abuts against the spring holding portion 126 at a first circumferential side and the other one abuts against the reset holding portion 462 on a second circumferential side opposite to the first circumferential side. That is, a reset elastic force used for enabling the knob transmission member 12 and the case 46 to return to initial positions is provided to the knob transmission member 12 and the case 46 in such a manner that the two limiting legs 132 abut against the spring holding portion 126 and the reset holding portion 462. The case further includes a rotation limiting portion 464 protruding towards its inner side. The rotation limiting portion 464 is disposed in a movement path of the limiting legs 132 and can abut against the limiting legs 132, thereby preventing the knob assembly 10 from excessively rotating. In this embodiment, the case 46 is provided with two rotation limiting portions 464 therein, and the two rotation limiting portions 464 are respectively disposed on two sides of the reset holding portion 462 in the peripheral direction.

Reference is made to FIG. 1 to FIG. 3. The lock of this embodiment further includes a positioning assembly, wherein the positioning assembly is at least partially fixed relative to the first component to be locked, one of the positioning assembly and the shifting transmission member 32 includes an elastically deformable positioning portion 43 and the other one includes a limiting portion 326 corresponding to the positioning portion 43. In this embodiment, the positioning portion 43 is a positioning elastic member. The positioning portion 43 is fixedly disposed on the mounting seat 41 by means of a positioning fixing plate 42. The limiting portion 326 is disposed on the shifting transmission member 32. A plurality of grooves are defined at intervals along the circumferential direction in an outer peripheral surface of one end of the limiting portion 326 facing the first side. The positioning portion 43 includes a protrusion corresponding to the groove, and the positioning portion 43 can elastically deform, so as to be in elastic releasable fit with the grooves when the shifting transmission member 32 rotates.

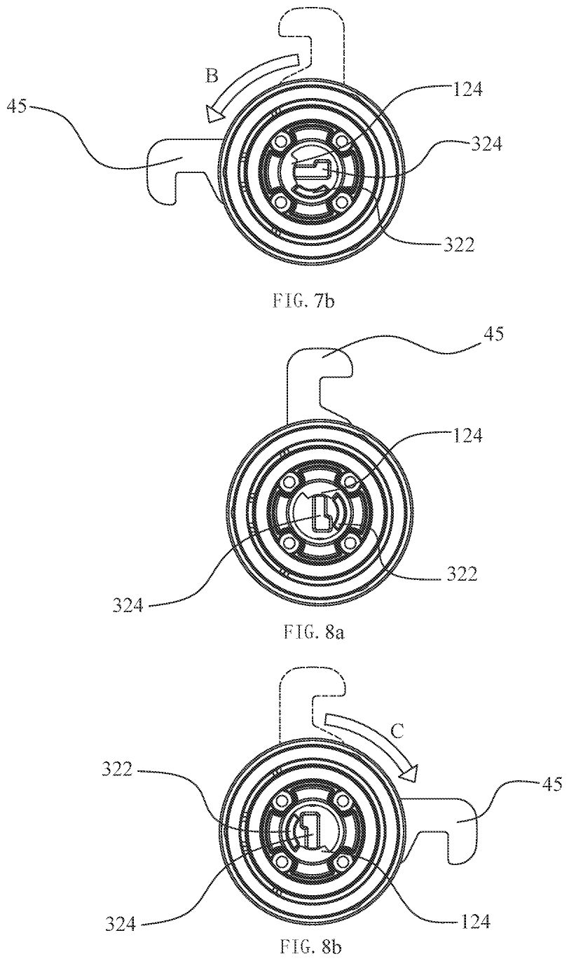

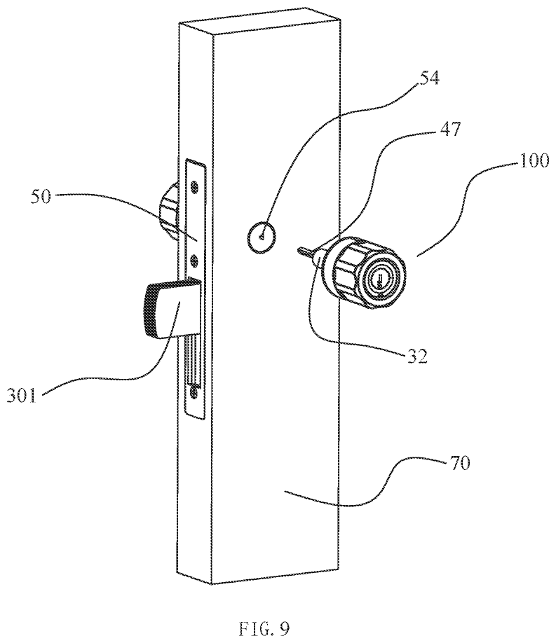

Reference is made to FIG. 7a and FIG. 8b. In this embodiment, the shifting transmission member 32 has two setting states, which are respectively a first setting state and a second setting state obtained by mounting in a manner of rotating the shifting transmission member 32 about the mounting direction by 180° from the first setting state. In the first setting state, as shown in FIG. 7a and FIG. 7b, the first transmission member 124 is adjacent to the second transmission member 322 in a first rotation direction B when not being driven. The first transmission member 124 can drive the second transmission member 322 to a locking position in the first rotation direction B when rotating along the first rotation direction B. In the second setting state, as shown in FIG. 8a, the first transmission member 124 is adjacent to the second transmission member 322 in a second rotation direction C opposite to the first rotation direction B when not being driven. The first transmission member 124 can drive the second transmission member 322 in the second rotation direction C when rotating along the second rotation direction C. Therefore, by changing the setting state of the shifting transmission member 32, the latching member 45 can rotate towards either the first rotation direction B or the second rotation direction C by means of the shifting transmission member 32, which ensures that the lock of the present disclosure can be installed on the first component to be locked and work normally without replacing parts regardless of whether the first component is open by rotating leftwards or rightwards. Here, the latching member 45 may also be formed to have two setting states. For example, as shown in FIG. 7a to FIG. 8b, the latching member 45 is formed into a sheet shape, and can still be installed to the shifting transmission member 32 in case that its two side surfaces are reversed, provided that a direction of the connecting portion of the latching member 45 is reversed. It should be understood that the latching member 45 may be arranged to be in other shapes, or have a greater length and the like as long as it can be latched with the second component.

Particularly, in the step of achieving locking with the lock according to the above embodiments. When the lock is installed on a first component and in an undriven state, the latching member 45 is in a first position decoupled from the second component, and the connecting portion of the latching member 45 is not connected with the second component. When the knob 11 is driven by an external driving force without inserting the key to rotate in a first direction for locking, the knob transmission member 12 receives a torque transferred by the knob 11, thereby rotating along the first direction. One of the legs of the torsion spring 13 is pushed against along the first direction by the spring holding portion 126 on the knob transmission member 12, and the other leg pushes against the reset holding portion 462 along the first direction on the other side of the reset holding portion 462 of the case 46, such that the torsion spring 13 provides a return spring force acting in a second direction opposite to the first direction during the rotation of the knob 11 in the first direction. Moreover, the first transmission member 124 of the knob transmission member 12 abuts against and pushes the second transmission member 322 of the shifting transmission member 32 along the first direction, such that the shifting transmission member 32 rotates in the first direction until the limiting portion 326 on the outer peripheral side surface of the shifting transmission member 32 is in elastic fit with the positioning portion 43, i.e., the protrusion of the positioning portion 43 enters a groove on an outer peripheral surface of the shifting transmission member 32. The latching member 45 connected with the shifting transmission member 32 is driven by the rotation of the shifting transmission member 32, and then the latching member 45 moves to the second position coupled with the second component to complete the locking. At this time, if the knob assembly 10 is further rotated in the first direction, the legs of the torsion spring 13 pushed by the spring holding portion 126 in the first direction will abut against the rotation limiting portion 464 in the first direction, which prevents the knob assembly 10 from further rotating in the first direction.

In the above locking process, the cylinder housing 19 rotates together with the knob assembly 10, and the cylinder core 34 is driven by the cylinder housing 19 and rotates in the first direction. Since the cylinder core 34 is in clutch connection with the spindle 31, the spindle 31 is driven by the cylinder core 34 to rotate in the first direction when the cylinder core 34 rotates in the first direction. However, since the spindle 31 is in clearance fit with the spindle interface 324 of the shifting transmission member 32, and the shifting transmission member 32 has been driven to rotate in the first direction by the knob transmission member 12, thus no torque is transferred to the shifting transmission member 32 through the spindle interface 324 from the spindle 31.

After the locking step is completed, the external driving force to the knob 11 can be released, and by this time, the knob assembly 10 automatically rotates and returns in the second direction under the elastic force of the torsion spring 13. However, the shifting transmission member 32 does not move since the limiting portion 326 on the outer peripheral side surface of the shifting transmission member 32 is engaged with the positioning portion 43. Moreover, since the spindle 31 is in the clutch type transmission connection with the cylinder core 34, when the cylinder core 34 rotates in the second direction without exceeding the clutch angle range, the spindle 31 can maintain its position without moving with the rotation of the cylinder core 34 in the second direction. At this time, since the shifting transmission member 32 has been positioned at a position for locking, even if the knob assembly 10 is rotated towards the first direction or the second direction, the knob assembly 10 cannot drive the shifting transmission member 32 to be released from the position for locking since the rotation assembly 10 is limited by the above-mentioned two rotation limiting portions 464. In this embodiment, the clutch angle range described herein is set such that the knob assembly 10 can rotate within an angle range defined between the two rotation limiting portions 464.

In the step of inserting the key to unlock, the cylinder core 34 and the cylinder housing 19 can freely rotate relative to each other due to the insertion of the key, and the cylinder core 34 can rotate in the second direction under the driving of the key, and drive the spindle 31 to rotate in the second direction. The spindle 31 further drives the shifting transmission member 32 to rotate in the second direction by its fitting with the spindle interface 324 of the shifting transmission member 32. The shifting transmission member 32 releases from the positioning elastic member by a driving force of the key, and then drives the latching member 45 to rotate in the second direction to complete the unlocking.

In addition, it should be understood that the key can be inserted into the cylinder core 34 and rotated towards the first direction, thereby driving the spindle 31 and the shifting transmission member 32 to lock.

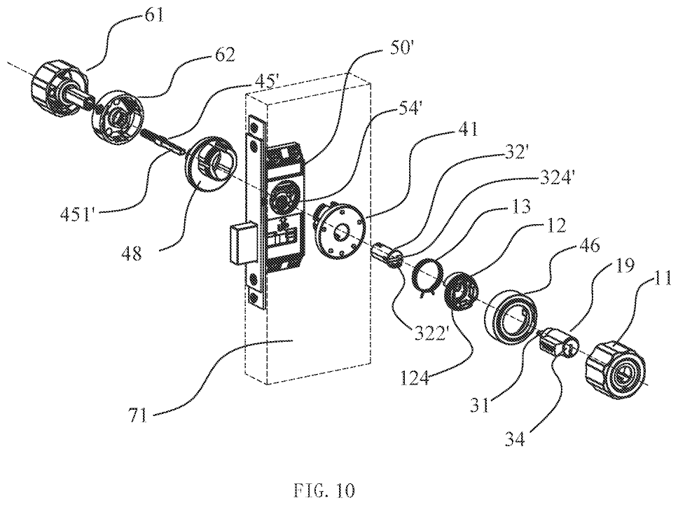

Reference is made to FIG. 9. In an optional embodiment, a locking assembly of the lock 100 according to the above-mentioned embodiment may further include a lock body 50, wherein the lock body 50 may be driven by a latching member 45. Alternatively, in other embodiments, the latching member can be formed to be in other forms, such as a rod-shaped latching member 47 as shown in FIG. 9, one end of the latching member is fixedly connected with the shifting transmission member 32 and the other end thereof is connected to a drive connecting portion 54 of the lock body. The lock 100 is disposed on a first component 70, and drives a lock bolt 301 of the lock body 50 to move for achieving locking. In this embodiment, the lock bolt 301 is a dead bolt, also called as a square bolt, that is, the lock bolt 301 does not include an inclined plane for a latch bolt. When a lock with the dead bolt is locked or unlocked, a control component of the lock must be operated to control the extension or retraction of the dead bolt. In contrast, in the case of using the latch bolt, generally, it only requires an object to touch and thrust the inclined plane of the latch bolt perpendicular to an extending direction of the latch bolt to push the latch bolt to retract. Therefore, compared with the latch bolt, the dead bolt structure is safer.

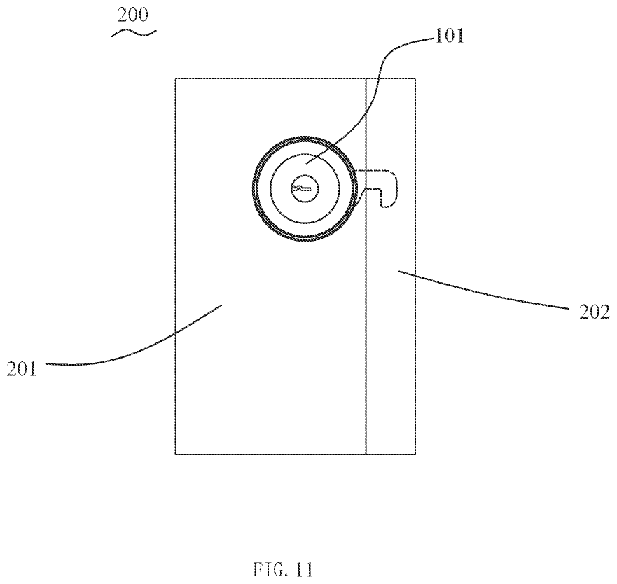

FIG. 10 shows another embodiment of a lock according to the present disclosure, wherein the lock includes a driving assembly, a knob assembly, a transmission assembly, a fixing assembly and a locking assembly similar to the above-described embodiment. In this embodiment, the driving assembly includes a cylinder housing 19. The knob assembly includes a knob 11 and a knob transmission member 12. The transmission assembly includes a cylinder core 34 and a spindle 31. This embodiment is different from the previous embodiments in that the transmission assembly in this embodiment includes a shifting transmission member 32′, and one end of the shifting transmission member 32′ includes a second transmission member 322′ and a spindle interface 324′, the second transmission member 322′ is configured to be in torque-transmission connection with the first transmission member 124 of the knob transmission member 12, and is driven to move when being abutted against by the first transmission member 124. The other end of the shifting transmission member 32′ includes a transmission member receiving hole, which is configured to receive a latching member 45′ and is in torque-transmission connection with the same. In this embodiment, the transmission connection is a form fit connection. The latching member 45′ includes a driving rod 451′ for connection with the lock body 50′, the driving rod 451′ passes through a driving connecting portion 54′ on the locking body 50′, and is in torque-transmission connection with the driving connecting portion 54′. In this embodiment, the driving rod 451′ has a trapezoidal cross section, and the driving connecting portion 54′ is formed as a trapezoidal hole substantially corresponding to the trapezoidal cross section, such that the rotation of the locking piece 45′ can be transferred to the lock body 50′ through the form fit connection with the drive connecting portion 54′.

The lock further includes a second fixing seat 48 disposed on the other side of the door, a second mounting seat 62 fixed relative to the second fixing seat 48, and a second knob 61 rotatably installed to the second mounting seat 62, wherein the second knob 61 includes a transmission member receiving hole, and the transmission member receiving hole is configured to receive the latching member 45′.

In this embodiment, the driving connecting portion 54′ on the lock body 50′ has another setting state. In this setting state, the driving connecting portion 54′ is arranged by rotating 180°. At this time, only the latching member 45′ and the shifting transmission member 32′ are required to be rotating 180° to achieve installation. For the rotation of the shifting transmission member 32′, an additional adjusting rod may be provided for auxiliary installation, and the adjusting rod has an adjusting end portion which is in form fit with the transmission member receiving hole of the shifting transmission member 32′ and a thinner rod portion which can make the adjusting end portion pass through the drive connecting portion 54′ on the lock body 50′ and rotate. At this time, the thinner rod portion will not be in torque-transmission connection with the driving connecting portion 54′. In this way, the adjusting rod can rotate the shifting transmission member 32′ so as to adjust it to a desired setting state. Similar to the embodiments described above, the lock with the additional setting state can be installed on both a first component opened leftwards and a first component opened rightwards without replacing or modifying parts of the lock. It should be understood that, in order to clearly distinguish the two setting states, the shifting transmission member 32′, the driving connecting portion 54′ and the latching member 45′ can be provided with signs for distinguishing the two mounting states, so as to prevent from being installed incorrectly.

During installation, firstly, the mounting seat 41, the shifting transmission member 32′, the torsion spring 13, the knob transmission member 12, the case 46, the spindle 31, the cylinder core 34, the cylinder housing 19, and the knob 11 are combined in sequence, and installed on one side of the first component 71 to be locked. The lock body 50′ is embedded in the first component 71 to be locked, wherein the lock bolt of the lock body can be extended out or retracted in relative to the first component 71. After that, the latching member 45′ is inserted into and pass through the transmission connecting portion 54′ of the lock body 50′, such that the latching member 45′ passes through the lock body 50′ and is in torque-transmission connection with the shifting transmission member 32′. In this step, if the setting state of the shifting transmission member 32′ needs to be adjusted, the above adjusting rod can be used to adjust the shifting transmission member 32′. After the latching member 45′ is inserted in place, the second fixing seat 48, the second mounting seat 62 and the second knob 61 can be installed on the other side of the first component 71 at one time. The second knob 61 includes a receiving portion for receiving the latching member 45′, and the receiving portion is in torque-transmission fit with the latching member 45′, such that the second knob 61 can control the locking or unlocking of the lock. In this embodiment, the lock bolt of the lock body 50′ is a dead bolt.

Reference is made to FIG. 11. In an alternative embodiment, the lock 101 according to one of the above embodiments can be used in an apparatus 200, wherein the apparatus 200 includes at least one first portion 201. The lock 100 according to one of the embodiments of the present disclosure is installed on the first portion 201. The apparatus further includes a second portion 202. The lock 100 can secure the first portion 201 relative to the second portion 202.

It should be understood that, the locking referred to herein means that the locking assembly makes the first component unmovable relative to the second component and cannot be released in an unsafe manner. For example, the locking assembly cannot be simply released by components such as knobs, buttons and handles, but needs to be unlocked and released in a way that can be authenticated and secured by keys, fingerprints, and magnetic cards.

In the present disclosure, under a continuous action of an external torsion force, the knob can continuously rotate, thereby driving the locking assembly, such that a dead-locking operation can be completed without a key. The lock according to the present disclosure simplifies the steps required to lock the door in the past, and saves the user's time and effort. In addition, since no key is required to lock the door, the safety of using the lock is improved.

It should be understood that, the above specific embodiments of the present disclosure are only intended to illustrate or explain the principle of the present disclosure, but not to limit the present disclosure. Therefore, any modifications, equivalent substitutions, improvements and the like made without departing from the spirit and scope of the present disclosure should be included within the protection scope of the present disclosure. Furthermore, the appended claims of the present disclosure are intended to cover all variants and modifications that fall within the scope and boundary of the appended claims, or the equivalents of such scope and boundary.

What is claimed is:

1. A lock for releasably locking a first component to a second component, characterized by comprising:
a driving assembly, configured to be installed on the first component and comprising a rotatable cylinder housing;
a transmission assembly, comprising a cylinder core which is insertable by a key and is in torque-transmission connection with the driving assembly;
a locking assembly, connected with the transmission assembly and having a first position decoupled from the second component and a second position coupled with the second component,
wherein the driving assembly is movable relative to the first component and drive the locking assembly by means of the movement to complete the locking, and the locking comprises: making the locking assembly move to the second position from the first position and be locked there.

2. The lock according to claim 1, wherein the driving assembly comprises an extending portion at least partially protruding from the first component and configured to receive an external driving force.

3. The lock according to claim 2, further comprising a knob assembly in torque-transmission connection with the driving assembly, wherein the knob assembly receives the external driving force, and drives the driving assembly to move.

4. The lock according to claim 3, wherein the knob assembly is covered on an outer side of one end of the transmission assembly away from the locking assembly.

5. The lock according to claim 3, wherein the knob assembly is in torque-transmission connection with the locking assembly, and drives the locking assembly to move, thereby completing the locking.

6. The lock according to claim 3, wherein the transmission assembly comprises an intermediate transmission member, wherein the knob assembly is in torque-transmission connection with the intermediate transmission member, the transmission assembly comprises a spindle; the spindle is in torque-transmission connection with the cylinder core and is in torque-transmission connection with the intermediate transmission member; the intermediate transmission member is drivable by the knob assembly or the spindle to move, such that the intermediate transmission member drives the locking assembly to complete the locking.

7. The lock according to claim 6, wherein the knob assembly comprises a first transmission member, the intermediate transmission member comprises a second transmission member, and the second transmission member is drivable by the first transmission member to move, thereby driving the locking assembly to complete the locking.

8. The lock according to claim 7, wherein the knob assembly comprises an inner opening, the first transmission member protrudes radially inwardly from the inner opening, and the second transmission member protrudes towards the inner opening.

9. The lock according to claim 7, wherein the knob assembly comprises a knob transmission member, and the inner opening is provided in the knob transmission member.

10. The lock according to claim 7, wherein the intermediate transmission member comprises a spindle interface, wherein the spindle interface is in clearance fit with the spindle, and the intermediate transmission member is drivable by the spindle to move through the spindle interface.

11. The lock according to claim 7, wherein the intermediate transmission member has a first setting state and a second setting state, wherein in the first setting state, the second transmission member is disposed on a path along which the first transmission member moves in a first direction, and is drivable by the first transmission member; and in the second setting state, the second transmission member is disposed on a path along which the first transmission member moves in a second direction opposite to the first direction, and is drivable by the first transmission member.

12. The lock according to claim 6, wherein the transmission connection between the knob assembly and the intermediate transmission member is clutch connection, and the transmission connection between the spindle and the intermediate transmission member is torque-proof connection, wherein when the spindle or the knob assembly moves in the first direction, the locking assembly is driven by the intermediate transmission member to complete the locking; and when the spindle moves in the second direction, the locking assembly is driven to move from the second position to the first position to achieve unlocking.

13. The lock according to claim 6, wherein the locking assembly comprises a latching member, wherein the latching member is in torque-transmission connection with the intermediate transmission member, and the latching member comprises a connecting portion which is fixedly connectable with the second component.

14. The lock according to claim 13, wherein the latching member is formed to be installed on the intermediate transmission member reversely, and after the latching member is reversely installed on the intermediate transmission member, the connecting portion is movable in a direction opposite to that before the latching member is reversely installed on the intermediate transmission member, and is fixedly connected with another second component disposed in an orientation opposite to that of the second component.

15. The lock according to claim 6, wherein the locking assembly comprises a lock body and a latching member, wherein the latching member is in torque-transmission connection with the intermediate transmission member, and the lock body is driven by the latching member to complete the locking.

16. The lock according to claim 15, wherein the lock further comprises a second knob, wherein the latching member is disposed through the lock body, one end of the latching member is in torque-transmission connection with the second knob and the other end of the latching member is in torque-transmission connection with the intermediate transmission member, such that the lock body is drivable to be locked or unlocked by rotating the second knob.

17. An apparatus, comprising:
a lock according to claim 1;
a first component and a second component;
wherein the first component is connected with the lock, and the lock is configured to releasably lock the first portion to the second portion.
